(19) United States
(12) Patent Application Publication
(10) Pub. No.: US 2015/0214717 A1
(43) Pub. Date: Jul. 30, 2015

(54) POWER SUPPLY SYSTEM FOR MACHINES

(71) Applicant: Caterpillar Inc., Peoria, IL (US)

(72) Inventors: Raghu Satyanaryana Rao, Decatur, IL (US); Justin M. Krager, Germantown Hills, IL (US); Joseph L. Rottman, Decatur, IL (US)

(73) Assignee: Caterpillar Inc., Peoria, IL (US)

(21) Appl. No.: 14/681,124

(22) Filed: Apr. 8, 2015

(51) Int. Cl. H02H 3/08; F01M 11/10; F01M 5/02

(52) U.S. Cl. CPC H02H 3/08; F01M 5/025; F01M 11/10

(57) ABSTRACT

A power supply system for a machine, to control a supply of electric current, is disclosed herein. The machine includes an engine, which operates in an active mode and an inactive mode. The engine is operably connected to an alternator, a pre-lube pump, and a battery unit. The power supply system includes a circuit breaker system. The circuit breaker system includes a common circuit breaker electrically connected between the battery unit and each of the alternator and the pre-lube pump. The circuit breaker system communicates the supply of electric current between the alternator and the battery unit, through the common circuit breaker corresponding to the active mode of operation of the engine. The circuit breaker system communicates the supply of electric current between battery unit and the pre-lube pump, through the common circuit breaker corresponding to the inactive mode of operation of the engine.

### TECHNICAL FIELD

The present disclosure relates generally to a power supply system for machines. More specifically, the present disclosure relates to the use of a common circuit breaker within the power supply system to protect a battery unit, an alternator, a pre-lube pump and/or associated cables from electrical surges.

### BACKGROUND

Various machines including an engine are known to employ a power supply system that controls the supply of electric current between a battery unit, an alternator, and a pre-lube pump, associated with the engine. The power supply system facilitates a supply of electric current from the battery unit to the pre-lube pump, in an inactive mode of operation of the engine. In addition, the power supply system facilitates a supply of electric current from the alternator to the battery unit, in an active mode of operation of the engine. In certain situations, such as but not limited to, a short to ground of the pre-lube pump and/or the alternator, the electric current may have high surges. In such situations, an electrical circuitry of the battery unit, the alternator, the pre-lube pump and/or associated cables may be damaged. This may lead to electrical failure of the battery unit, the alternator, the pre-lube pump and/or the cables. Therefore, the power supply system commonly employs a circuit breaker system, to protect the battery unit, the alternator, the pre-lube pump, and/or the cables from those high surges of electric current.

Conventional circuit breaker systems include a circuit breaker electrically connected between the battery unit and the alternator. The circuit breaker electrically disconnects the alternator from the battery unit, to protect the battery unit, the alternator, and/or the cables (between the battery unit and the alternator) during such high surges of electric current between the battery unit and the alternator. In addition, conventional circuit breaker systems include a fuse apparatus electrically connected between the battery unit and the pre-lube pump. The fuse apparatus electrically disconnects the pre-lube pump from the battery unit, to protect the pre-lube pump the battery unit, and/or the cables (between the battery unit and the pre-lube pump) during such high surges of electric current between the battery unit and the pre-lube pump. However, such conventional circuit breaker systems are relatively bulky and is an additional failure point. For proper installation, the conventional circuit breaker systems may require a relatively large space as well.

PCT application number, WO 2,009,037,043 discloses a circuit breaker positioned between two energy accumulators, to control a supply of electric current to a consumer. Although this reference discloses the circuit breaker that controls the supply of electric current to a consumer, no reference provides the circuit breaker that controls the supply of electric current to each of the alternator and the pre-lube pump.

### SUMMARY OF THE INVENTION

One aspect of the present disclosure is directed towards a power supply for a machine to control a supply of electric current. The machine includes an engine configured to operate in an active mode and an inactive mode. The engine is operably connected to an alternator, a pre-lube pump, and a battery unit. The power supply system includes a circuit breaker system. The circuit breaker system includes a common circuit breaker electrically connected between the battery unit and each of the alternator and the pre-lube pump. The circuit breaker system is adapted to communicate the supply of electric current provided between the alternator and the battery unit, through the common circuit breaker corresponding to the active mode of operation of the engine. Moreover, the circuit breaker system is adapted to communicate the supply of electric current provided between the battery unit and the pre-lube pump, through the common circuit breaker corresponding to the inactive mode of operation of the engine.

Another aspect of the present disclosure is directed towards a method of protecting a pre-lube pump in a power supply system for a machine during a supply of electric current to the pre-lube pump. The machine includes an engine, which operates in an active mode and an inactive mode. The engine is operably connected to a battery unit and an alternator. The power supply system includes a circuit breaker system. The circuit breaker system includes a common circuit breaker electrically connected between the battery unit and the alternator. The circuit breaker system is adapted to communicate the supply of electric current provided between the alternator and the battery unit, through the common circuit breaker corresponding to the active mode of operation of the engine. The method includes connecting the pre-lube pump to the common circuit breaker of the circuit breaker system. The circuit breaker system communicates the supply of electric current provided between the battery unit and the pre-lube pump, through the common circuit breaker corresponding to the inactive mode of operation of the engine.

### BRIEF DESCRIPTION OF THE DRAWINGS

FIG. 1 is a perspective view of a frame of a machine that illustrates an engine and an electrical system associated with the engine, in accordance with the concepts of the present disclosure; and

FIG. 2 is a block diagram of a power supply system that controls the supply of electric current between a battery unit and each of a pre-lube pump and an alternator associated with the engine of FIG. 1.

### DETAILED DESCRIPTION

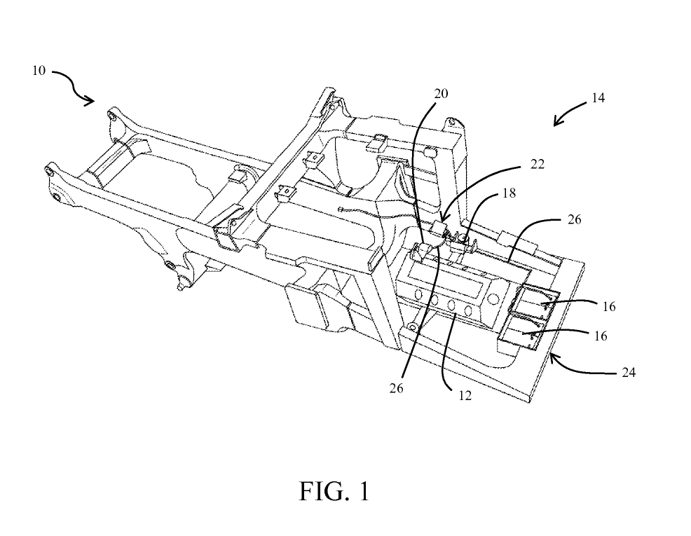

Referring to FIG. 1, a frame 10 of a machine (not shown) that supports an engine 12 and an electrical system 14 associated with the engine 12, is shown. The engine 12 may be a multi-cylinder engine configured to be employed in the machine (not shown), such as but not limited to, an off-highway truck, a mining truck, a skid steer loader, and/or a wheel loader. The engine 12 is generally mounted adjacent to a frontal end 24 of the frame 10 and is adapted to operate in an active mode and an inactive mode. As is customarily known, the engine 12 is operative in the active mode of operation and is inoperative in the inactive mode of operation.

In the current embodiment of disclosure, the electrical system 14 includes an electric starting system (not shown), a battery unit 16, a pre-lube pump 18, an alternator 20, and a power supply system 22. The electrical system 14 may operate in one of an energized state and a de-energized state. In the de-energized state of the electrical system 14, the electrical starting system (not shown) is inoperative and the engine 12 is in the inactive mode of operation. In the energized state, the electrical starting system (not shown) of the electrical system 14 switches the engine 12 from the inactive mode of operation to the active mode of operation. More specifically, the electric starting system (not shown) uses a portion of electrical energy from the battery unit 16, to start the engine 12. Before starting, the engine 12 is lubricated by the pre-lube pump 18, to facilitate smooth start of the engine 12. The pre-lube pump 18 uses a portion of electrical energy from the battery unit 16, to operate and lubricate the engine 12 in the inactive mode of operation of the engine 12. Moreover, the battery unit 16 is automatically recharged by the alternator 20 and/or by an external source in the active mode of operation of the engine 12. Although, the present disclosure contemplates use of a separate pre-lube pump 18 for lubrication of the engine 12 in the inactive mode of operation, it may be contemplated that an engine lubrication pump may be used as the pre-lube pump 18, for lubrication of the engine 12 in the inactive mode of operation.

In the current embodiment, the battery unit 16 is an energy accumulator device mounted at the frontal end 24 of the frame 10. The battery unit 16 is electrically connected to the electric starting system (not shown) of the engine 12, to facilitate start of the engine 12. Moreover, the battery unit 16 is electrically connected to each of the alternator 20 and the pre-lube pump 18 via the power supply system 22. The electrical connection between the battery unit 16 and each of the alternator 20 and the pre-lube pump 18 via the power supply system 22 is facilitated with use of a multiplicity of electrical cables 26.

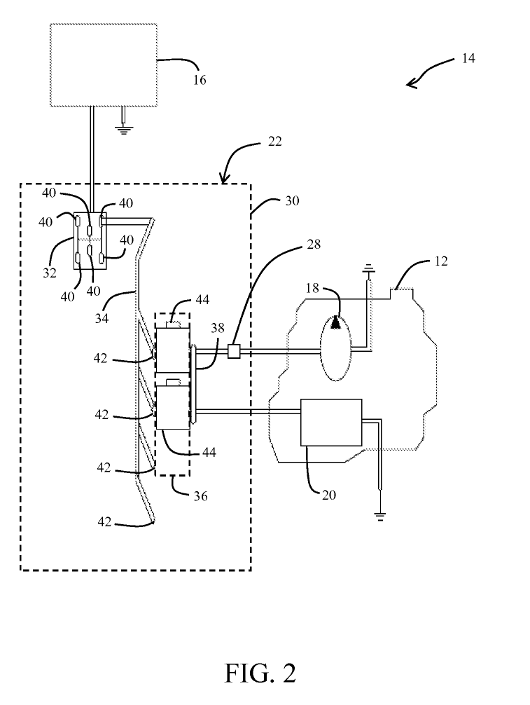

The pre-lube pump 18 may be a lubrication pump fluidly connected to an engine block (not shown) of the engine 12. Upon actuation, the pre-lube pump 18 supplies lubrication oil to the engine block (not shown) of the engine 12, and facilitate lubrication of the engine 12. The pre-lube pump 18 is electrically connected to the battery unit 16, via the power supply system 22 and is controlled by an inline magnetic switch 28 (FIG. 2). When the Magnetic switch 28 (FIG. 2) is turned on, the battery unit 16 supplies electric current to the pre-lube pump 18 via the power supply system 22, to actuate the pre-lube pump 18 in the inactive mode of operation of the engine 12. It will be understood that excessive parasitic loads should be prevented from connecting with the pre-lube pump 18 and therefore the pre-lube pump 18 is turned off via the magnetic switch 28 (FIG. 2) during engine cranking (active mode of operation), to improve the life of the pre-lube pump 18.

The alternator 20 may be an electric generator mounted on the engine 12. As is customarily known, the alternator 20 includes an arrangement of a rotary shaft (not shown) and a stator winding (not shown). The rotary shaft (not shown) is connected to a crankshaft (not shown) of the engine 12 via a belt arrangement (not shown). The stator winding (not shown) is electrically connected to the battery unit 16 via the power supply system 22. The alternator 20 is adapted to receive a portion of mechanical energy from the crankshaft (not shown) of the engine 12, convert the mechanical energy to electrical energy, and supply the electrical energy (electric current) to the battery unit 16. The alternator 20 supplies electric current to the battery unit 16 via the power supply system 22 in the active mode of operation of the engine 12. As the crankshaft (not shown) is operable in the active mode of operation of the engine 12, the alternator 20 is electrically disconnected in the inactive mode of operation of the engine 12.

Referring to FIG. 2, there is shown a schematic of the power supply system 22 that controls the supply of electric current between the battery unit 16 and each of the pre-lube pump 18 and the alternator 20. The power supply system 22 includes a circuit breaker system 30, electrically connected between the battery unit 16 and each of the pre-lube pump 18 and the alternator 20. The circuit breaker system 30 of the power supply system 22 is adapted to control the supply of electric current provided between the battery unit 16 and each of the pre-lube pump 18 and the alternator 20. More specifically, while in the active mode of operation of the engine 12, the circuit breaker system 30 electrically communicates the supply of electric current from the alternator 20 to the battery unit 16. In addition, while in the inactive mode of operation of the engine 12, the circuit breaker system 30 electrically communicates the supply of electric current provided from the battery unit 16 to the pre-lube pump 18. The circuit breaker system 30 includes a junction box 32, a first buss bar 34, a common circuit breaker 36, and a second buss bar 38.

The junction box 32 is electrically connected to the battery unit 16 and includes a multiplicity of connection ports 40, which facilitate an electric connection between the battery unit 16 and various other electrical ancillaries. The first buss bar 34 is electrically connected to one of the connection ports 40 of the junction box 32. The first buss bar 34 includes a number of connection terminals 42, to which the common circuit breaker 36 may be connected. In the exemplary embodiment, the common circuit breaker 36 includes two circuit breakers 44, connected to two connection terminals 42 of the first buss bar 34. Although usage of two circuit breakers 44 is described in the embodiment of the present disclosure, usage of a singular circuit breaker connected to the first buss bar 34 may also be contemplated. However, number of circuit breakers 44 does not limit the scope of the present disclosure. In an exemplary embodiment, the circuit breaker 44 may be a manual type circuit breaker that protects the battery unit 16 and the pre-lube pump 18, during high surges of electric current. Although the circuit breaker 44 is described as the manual type circuit breaker, however other circuit breakers known to those having ordinary skill are also contemplated by the present disclosure. The second buss bar 38 is electrically connected to the common circuit breaker 36 of the circuit breaker system 30. The second buss bar 38 facilitates a connection between the common circuit breaker 36 and each of the pre-lube pump 18 and the alternator 20. The specific arrangement of the circuit breaker system 30 facilitates the common circuit breaker 36 to be electrically connected in parallel between the battery unit 16 and each of the pre-lube pump 18 and the alternator 20. This allows the common circuit breaker 36 to protect the pre-lube pump 18 and the alternator 20 at times of high surges of electric current between the battery unit 16 and each of the pre-lube pump 18 and the alternator 20.

### INDUSTRIAL APPLICABILITY

In operation, an operator may energize the electrical system 14 associated with the engine 12, to start the engine 12. In the energized state of the electrical system 14, the engine starting system (not shown) cranks the engine 12 at sufficient speed to begin the combustion of fuel in each of its cylinders and keep the engine 12 running. Startability of the engine 12 is affected by factors such as ambient temperature, engine jacket water temperature, and lubricating oil viscosity. In addition, parasitic loads, usually associated with the driven equipment, can greatly influence the startability. For this purpose, the pre-lube pump 18 is utilized that reduces engine wear by automatically building engine oil pressure before the engine 12 is allowed to crank. Therefore, the pre-lube pump 18 precedes an engine start and is disconnected as the engine 12 is up running.

The engine 12 is in the inactive mode of operation, before the cranking of the engine 12. In the inactive mode of operation, the magnetic switch 28 actuates the pre-lube pump 18, to enable pre-lubrication. For this purpose, the battery unit 16 supplies electric current to the pre-lube pump 18. Moreover, the pre-lube pump 18 is required to be protected at times of high surges of electric current, during the supply of electric current from the battery unit 16 to the pre-lube pump 18. A method of protecting the pre-lube pump 18 (during the supply of electric current from the battery unit 16 to the pre-lube pump 18) includes connecting the pre-lube pump 18 to the common circuit breaker 36 via the magnetic switch 28 of the circuit breaker system 30. This connection facilitates the circuit breaker system 30 to enable the supply of electric current from the battery unit 16 to the pre-lube pump 18, through the common circuit breaker 36. In situations of high surges of electric current, the common circuit breaker 36 may break the electrical connection between the battery unit 16 and the pre-lube pump 18. This discontinues the supply of electric current form the battery unit 16 to the pre-lube pump 18. Therefore, the common circuit breaker 36 protects an electric circuitry of the pre-lube pump 18 and/or cables 26 (between the battery unit 16 and the pre-lube pump 18) from damage at times of high surges of electric current.

Furthermore, as the engine 12 is cranked by the electric starting system (not shown), the engine 12 switches from the inactive mode to the active mode. In the active mode of operation, the pre-lube pump 18 is inoperative and the alternator 20 supplies electric current to the battery unit 16, through the power supply system 22. More specifically, while in the active mode of operation of the engine 12, the circuit breaker system 30, electrically communicates the supply of electric current from the alternator 20 to the battery unit 16, through the common circuit breaker 36. In certain situation, such as high surges of electric current, the common circuit breaker 36 may break the electrical connection between the alternator 20 and the battery unit 16. This discontinues the supply of electric current from the alternator 20 to the battery unit 16. In addition, this protects an electric circuitry of the battery unit 16 and/or cables 26 (between the battery unit 16 and the alternator 20) from damage at times of relatively high surges of electric current.

Furthermore, it may be noted that the same common circuit breaker 36 protects each of the battery unit 16 (in the active mode) and the pre-lube pump 18 (in the inactive mode). Therefore, a need for a separate circuit breaker (or a fuse apparatus) for each of the alternator 20 and the pre-lube pump 18, is eliminated. This provides a relatively compact circuit breaker system 30 and reduces the overall cost of the power supply system 22. Therefore, the power supply system 22, assists in protecting electrical circuitry attached to both of the alternator 20 and the pre-lube pump 18 from short to grounds by utilizing the common circuit breaker 36.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A power supply system for a machine to control a supply of electric current, the machine including an engine configured to operate in an active mode and an inactive mode, the engine being operably connected to an alternator, a pre-lube pump, and a battery unit, the power supply system comprising:
a circuit breaker system including:
a common circuit breaker electrically connected between the battery unit and each of the alternator and the pre-lube pump, the circuit breaker system being adapted to communicate the supply of electric current being provided between the alternator and the battery unit, through the common circuit breaker corresponding to the active mode of operation of the engine and to communicate the supply of electric current being provided between the battery unit and the pre-lube pump, through the common circuit breaker corresponding to the inactive mode of operation of the engine.

2. A method of protecting a pre-lube pump in a power supply system for a machine during a supply of electric current to the pre-lube pump, the machine including an engine adapted to operate in an active mode and an inactive mode, the engine being operably connected to a battery unit and an alternator, the power supply system including a circuit breaker system, the circuit breaker system including a common circuit breaker electrically connected between the battery unit and the alternator, the circuit breaker system being adapted to communicate the supply of electric current being provided between the alternator and the battery unit, through the common circuit breaker corresponding to the active mode of operation of the engine, the method comprising:
connecting the pre-lube pump to the common circuit breaker of the circuit breaker system, wherein the circuit breaker system communicates the supply of electric current being provided between the battery unit and the pre-lube pump, through the common circuit breaker corresponding to the inactive mode of operation of the engine.
